(19) United States
(12) Patent Application Publication
(10) Pub. No.: US 2005/0241408 A1
(43) Pub. Date: Nov. 3, 2005

(54) Load Cell Insensitive to Angular Misalignments and Shock Loads

(76) Inventor: Jon Zan Scoot, Greenville, SC (US)

Correspondence Address: JEFFREY FURR, 253 N. MAIN STREET, JOHNSTOWN, OH, 43031, US

(21) Appl. No.: 10/709,316

(22) Filed: Apr. 28, 2004

(51) Int. Cl. G01N 3/24

(52) U.S. Cl. 73/841

(57) ABSTRACT

A new load cell design incorporates an integral spring into the body of the load cell. Compared to a standard S-cell, this spring does not reduce the load carrying capacity of the cell. The spring increases the deflection of the cell, yielding less sensitivity to angular misalignments, shock loads and overload stop setting errors.

### BACKGROUND OF INVENTION

1. Field of the Invention

This invention relates to load cells and more particularly to a load cell that provides a large deflection, rendering it insensitive to angular misalignments and shock loads.

2. Description of Prior Art

There is a long history of load cells designed to measure shear. The first shear-type load cells were in the form of a beam with a section usually in the middle designed to measure the shear force in the beam. The shear measuring section often uses wire or foil type strain gages and a variety of shear measuring strategies have been devised. Currently there are 3 common types. These are:

1. Strain gages that are placed on or near the neutral axis of the beam and oriented in the principal direction, usually at 45°.

2. Strain gages are placed inside a either round or rectangular hole that measures the deformation of the hole under shear loading. Although the beam is in bending and shear, the change in shape of the hole causes tensile and compressive strains to exist both above and below the neutral axis. The strain gages are carefully placed to measure these tensile and compressive strains. A Wheatstone bridge is usually used to produce a signal proportional to the shear force, while cancelling any signal due to the bending moment.

3. A hole or holes created as in 2. above, but the strain gages placed on the outside surface of the beam. In this design, the hole usually extends near the strain gage locations, so the gages again measure strains due to the deformation of the hole. As in 2. above, both tensions and compressions exist on both sides of the neutral axis due to deformation of the hole. Strain gages are placed to measure these tensile and compressive strains, producing a signal proportinal to the shear force and cancelling any signal due to the bending moment.

In all these designs, the beam must be restrained by applying a moment and a reaction parallel to the applied load to at least one end to prevent rotation, since the beam is in shear and bending.

One interesting variation of the above designs is to fold any of them such that one end of the beam is above the shear measuring section and the other end below it. These cells are called S-cells in the marketplace, because they have a shape that resembles the letter S. In this configuration, no moment need be applied to either end as the applied loads are collinear. Often, spherical joints are used if the cell is used in tension and the load cell becomes a two force member. The cell can also be used in compression with only nominal moments used to maintain alignment. However, the cell is intrinsically a shear measuring device, as a shear measuring section is used to convert shear deformation into an electrical signal, just as in its shear-beam ancestors.

Angular Misalignment

One frequent complaint about S-cells is that they produce an output in response to moments applied at their ends. This output is undesired as we would prefer to have an output due only to the compression or tension in a two force member. However, the cell is rarely a real two force member in that moments are usually applied, either intentionally or unintentionally. Therefore, the cells usually produce an output proportional to both the load and the moment and it is impossible to know how much of the output comes from the load and how much comes from the moment.

In tension, various approaches are used to reduce the applied moment and hence, the error caused by it. Spherical bearings, unable to transmit a moment, are sometimes affixed to the end of the load cell. If space permits, the cell is sometimes mounted in long, thin rods so that the rod is unable to support a moment and transmit it to the cell. Long thin cables are sometimes used in place of rods. All these approaches add cost and require more space for mounting.

In compression, the problem of eliminating moments is more difficult. If the object applying the compressive load is not constrained properly, using spherical bearings or long rods/cables is impossible, as moments must be applied to the cell to prevent it from rotating. It is a rare occurrence where an S-cell can be applied in compression and the surrounding equipment used to maintain the position of the cell. Therefore, moments are almost always intentionally applied to S-cells loaded in compression, usually by threaded fasteners.

Shock Loads

Another reason that S-cells are mounted in long rods or cables is to reduce the axial stiffness of the system formed by the cell and its mounting. Most S-cells will fail if they encounter axial loads 300% higher than their rated capacity. Shock loads can easily produce transient loads much, much higher than 300% of capacity. By reducing the spring constant of the system, the magnitude of the force peak can be reduced, although at the cost of reducing the natural frequency. In many cases, insufficient room exists for long rods and discrete springs are used, but these too require more space and mounting complexity.

Deflection

Most commercial S-cells have very small deflections at their rated capacity and a very small additional deflection as load is increased from the rated capacity to their point of failure. Hard overload stops are sometimes set such that the applied force will be diverted around the cell if the deflection exceeds the rated capacity but is less than the failure load. In low-cost assembly situations, the accuracy with which overload stops can be set is often of the same magnitude as the deflection of the cell between rated capacity and failure. This means that in some assemblies, the cell deflection would encounter an overload stop before reaching its rated capacity, giving the cell user an artificially low reading. In other assemblies, however, the cell would be allowed to deflect past the point where it was irreparably damaged before encountering the overload stop. Most scale makers must use great care and apply weights to each scale to ensure that the overload stops function as intended.

There is still room for improvement in the art.

### SUMMARY OF INVENTION

An object of the present invention is to incorporate a spring into a load cell, reducing its stiffness such that mounting misalignments, shock loads and overload stop setting are less of a problem than in current designs.

The inventor of the present invention has come up with a new load cell design that is less sensitive to misalignments of the members applying the load. The new design is much less likely to be damaged by shock loads as it is inherently more compliant than commercial designs. Overload stop setting is much easier on this cell, as the deflection of this cell, compared to commercial cells, is large between the point of rated capacity and failure. The incorporated spring adds very little to the size of the load cell and is much smaller than an assembly in which a spring could be added to a commercially-available load cell.

### BRIEF DESCRIPTION OF DRAWINGS

Without restricting the full scope of this invention, the preferred form of this invention is illustrated in the following drawings:

FIG. 1 is a view of a typical S-cell; and

FIG. 2 is a view of a load cell embodying the present Invention.

### DETAILED DESCRIPTION

The following description is demonstrative in nature and is not intended to limit the scope of the invention or its application of uses.

There are a number of significant design features and improvements incorporated within the invention. The current invention is a new load cell design incorporates an integral spring into the body of the load cell. Compared to a standard S-cell, this spring does not reduce the load carrying capacity of the cell. The spring increases the deflection of the cell, yielding less sensitivity to angular misalignments, shock loads and overload stop setting errors.

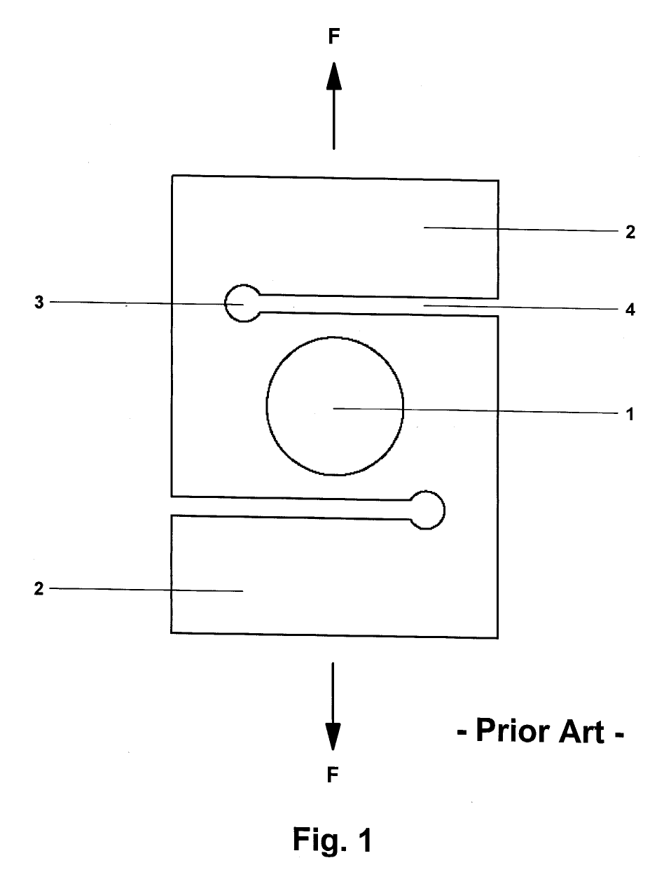

Referring initially to FIG. 1, there is shown an elevational side view of a prior art S-cell type load cell. The load is measured in the shear-measurement section 1. The arms 2 fold back over the shear measurement section such that the load F applied at the top is co-linear with the load F applied at the bottom arm. One hole 3 is drilled on each end of the cell at the end of the slot 4.

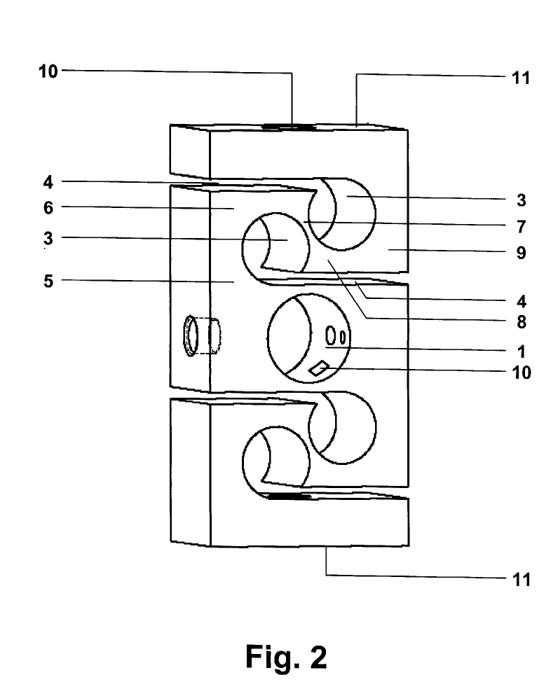

FIG. 2 shows one embodiment of the current invention, although many others are possible. The load cell 11 made of a rectangular barstock or material. A shear measurement section 1 generates an electrical signal proportional to the load. This is done through the use of strain gauges 10. The strain gauges 10 are of the resistance type that are commonly and commercially available for producing a change in resistance proportional to the strain. The load cell 11 would also include associated electronic circuitry (not shown) for processing the signal from the strain gauges 10. The shear measurement section 1 is a gagehole in the preferred embodiment and serves to weaken the load cell 11 to increase the strain so that it can accurately measure the shear force on the load cell 11 produced by an applied load. The shear measurement section 1 is also the preferred location to mount the strain gauge(s) 10. As displayed in FIG. 2 the strain gauges 10 are located on the circumference of the gage hole.

In the load cell 11, in the preferred embodiment, the arms 2 are generated by creating two large holes 3 on each end that overlap in both the transverse and longitudinal directions. In this embodiment, the overlap is greater in the longitudinal direction (in the direction of the applied force) to minimize the total load cell length in this direction. The holes are connected to the outside edges of the cell by the slots 4.

The number of holes 3 can vary. The existing designs use one hole 3 (see FIG. 1) and one slot 4. The embodiment in FIG. 2 has two holes 3 and two slots 4. However, the number of holes and slots could be increased as needed to further lower the stiffness of the load cell. Generally, more holes and slots cost more, so the number of holes and slots would be minimized to reduce cost.

The design of preferred embodiment in FIG. 2 is done to carefully equalize the stresses at points 5, 6, 7, 8 and 9. Thus equalizing the stresses results in the minimum stiffness with the highest possible failure load. The thicknesses at points 5, 6, 7, 8 and 9 should be varied to accomplish this equalization of stresses. In this embodiment, the minimum material thicknesses at points 5 and 9 are equal, but greater than the thicknesses at points 6 and 8. The thicknesses at points 6 and 8 are equal, but greater than the thickness at 7.

Although this design uses equal stresses at five points, an alternate embodiment would be a design in which the thickness varied continuously from the shear section 1 to the load application point 10, such that the surface stress at any point along the contour was equal. This design would be more expensive to produce, but would produce slightly greater deflection and a slightly higher failure point.

Another feature of the present design is that spring section below the shear section is created by taking a mirror image of the spring section above the shear section. This mirror image is then rotated 180° about the axis through the loading points 10 and shear section 1. This type of symmetry ensures that ends of the cell remain approximately parallel, irrespective of the number of holes 3 that appear on each end.

Advantages

This invention guarantees a load cell which is better able to survive and perform in an environment where the applied loads are not exactly colinear, where moments may be intentionally or unintentionally applied, where shock loads may exist or where overload stops must be set using fairly crude equipment.

The cell in FIG. 1 has only one point of bending on each end: at the hole 3. The cell in the embodiment of FIG. 2 has 5 points at which to deform: points 5, 6, 7, 8 and 9. These additional deformation points do not lower the load that can be applied to the cell 11 without catastrophic failure, as the stress at each point is the same and can be chosen equal to that in the cell of FIG. 1. These additional deformation points greatly increase the deflection of the load cell 11 without lowering its ability to carry load.

The additional deflection afforded by this new design is frequently advantageous. In applications where spherical bearings are used to connect to the cell 11, the bearings can often be eliminated as the end of the cell 11 can rotate to match the connecting members. The moment to achieve this rotation is much smaller than with the previous design of FIG. 1, such that the error it causes on the cell output is less than would be caused in the cell of FIG. 1 and can often be tolerated. The space and cost are also much smaller than adding spherical bearings, so that this cell can be used in tighter spaces and at lower total cost than the cell of FIG. 1. Since the S-cell of FIG. 1 often requires long rods or cables, the current invention can be used with very short rods or cables, enabling it to be used in places where there just isn't room for a prior art S-cell.

The current design lowers the peak shock load in any application in which it is installed, since the cell affords greater deflection. Lowering the peak shock load helps ensure the cell's survivability in hostile environments as well as the survival of parts attached to it. The spring incorporated into the load cell occupies less space than most practical designs of adding a spring to a standard S-cell. This design also requires no additional mounting hardware.

Setting overload stops is much easier with this design than the S-cell of FIG. 1 The S-cell's deflection is frequently small enough that the overload stop must be checked with applied forces to make sure that the stops will not engage before the rated capacity is reached, but that they always engage before the failure point of the cell (or of members attached to it) is reached. This difficulty in setting the overload stops is due to the difficulty of measuring very small gaps between surfaces that are misaligned or dirty. The greater deflection afforded by this cell, with no loss of load carrying ability, means that errors in setting the overload gaps may be much larger.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A device comprising:
a) load cell;
with a shear measurement section;
with material being removed to form a plurality of slots;
with two or more slots on either side of said shear measurement section which increases deformation points.

2. A device as claimed in claim 1 wherein said slots are connected to a hole within said load cell.

3. A device as claimed in claim 1 wherein said slots are use to equalize stress at deformation points

4. A device as claimed in claim 1 wherein said shear measurement section is a gage hole.

5. A device as claimed in claim 1 which has strain gages located in said shear measurement section.

6. A device as claimed in claim 4 which has strain gages located in said gage hole.

7. A device as claimed in claim 1 wherein there are two slots above said shear measurement section and two slots below said shear measurement section.

8. A device as claimed in claim 4 wherein there are two slots above said shear measurement section and two slots below said gage hole.

9. A device as claimed in claim 6 wherein there are two slots above said shear measurement section and two slots below said gage hole.

10. A device as claimed in claim 5 wherein there are two slots above said shear measurement section and two slots below said gage hole.

11. A process of measuring force loads using:
a) load cell;
with a shear measurement section;
with material being removed to form a plurality of slots;
with two or more slots on either side of said shear measurement section which increases deformation points.

12. A process as claimed in claim 11 wherein said slots are connected to a hole within said load cell.

13. A process as claimed in claim 11 wherein said slots are use to equalize stress at deformation points

14. A process as claimed in claim 11 wherein said shear measurement section is a gage hole.

15. A process as claimed in claim 11 which has strain gages located in said shear measurement section.

16. A process as claimed in claim 14 which has strain gages located in said gage hole.

17. A process as claimed in claim 11 wherein there are two slots above said shear measurement section and two slots below said shear measurement section.

18. A process as claimed in claim 14 wherein there are two slots above said shear measurement section and two slots below said gage hole.

19. A process as claimed in claim 16 wherein there are two slots above said shear measurement section and two slots below said gage hole.

20. A process as claimed in claim 15 wherein there are two slots above said shear measurement section and two slots below said gage hole.
